(19) United States
(12) Patent Application Publication
(10) Pub. No.: US 2017/0305006 A1
(43) Pub. Date: Oct. 26, 2017

(54) IMPACT TOOL

(71) Applicant: Apuren Co., Ltd., Toyota-shi (JP)

(72) Inventors: Yukio WATANABE, Toyota-shi (JP); Toshiyuki OKADA, Toyota-shi (JP)

(73) Assignee: Apuren Co., Ltd., Toyota-shi (JP)

(21) Appl. No.: 15/133,227

(22) Filed: Apr. 20, 2016

(51) Int. Cl. B25D 17/24; B25D 9/14

(52) U.S. Cl. CPC B25D 17/24; B25D 9/14; B25D 2250/371

(57) ABSTRACT

In an impact tool, a vibration absorbing body is fitted on the outside of an outer periphery of an operating body, and the vibration absorbing body is interposed between the operating body and the cover body. The vibration absorbing body includes a tubular main body, and ring bodies attached to be fitted into recessed grooves formed on an inner peripheral surface and an outer peripheral surface of the tubular main body along the circumferential direction and elastically deformed to expand or contract the outside diameter. The ring bodies are maintained in a state where the ring bodies are elastically contracted in a freely expanding or contracting manner.

### BACKGROUND OF THE INVENTION

### Field of the Invention

The present invention relates to an impact tool.

### Discussion of the Background

Conventionally, various types of impact tools have been proposed (see Japanese Patent No. 4340081, Japanese Patent No. 3825802, Japanese Patent No. 2746712, and Japanese Patent Application Publication No. H8-197458, for example). Also, a structure for preventing a vibration generated due to reciprocation of a piston installed in the tool from being transmitted to a worker has been disclosed (see Japanese Patent Application Publication No. H9-011156). For example, a structure in Japanese Patent Application Publication No. H9-011156 discloses a damping or shock-absorbing mechanism disposed at a rear end of an air hammer main body and includes a damping chamber which is filled with a damper liquid, a damper cylinder in which a damping body is fitted, and a communication hole that is formed in the damper cylinder to fluidly communicate between the damping chamber and the inside of the damper cylinder.

Furthermore, an impact tool with a coil spring is also known.

### SUMMARY OF THE INVENTION

According to one aspect of the present invention, an impact tool includes a cover body and a distal end work tool extending forward from said cover body for performing a task by abutment of said distal end work tool against a workpiece while gas is introduced into the inside of said cover body, wherein said cover body has an inner space portion formed along a longitudinal direction, a cylindrical operating body moving in the longitudinal direction or rotating about an axis along the longitudinal direction is mounted in said inner space portion, when gas is introduced to a rear side of said operating body, a hammer provided in said operating body reciprocates to impact repeatedly the distal end work tool thereby transmitting an impact force to the workpiece, a vibration absorbing body is disposed to be fitted on the outside of said operating body and interposed between an outer peripheral surface of said operating body and an inner peripheral surface of said cover body, said vibration absorbing body includes a tubular main body, and an elastically deformable ring body mounted onto each of an inner peripheral surface and an outer peripheral surface of said tubular main body along the circumferential direction, in a state where said vibration absorbing body is interposed between the outer peripheral surface of said operating body and the inner peripheral surface of said cover body, the inner peripheral surface of said ring body mounted on the inner peripheral surface of said tubular main body comes into contact with the outer peripheral surface of said operating body, and the outer peripheral surface of said ring body mounted on the outer peripheral surface of said tubular main body comes into contact with the inner peripheral surface of said cover body, said ring body is partially cut to have a gap and becomes elastically deformable to expand or contract the outside diameter of said ring body, in the state where said vibration absorbing body is interposed between the outer peripheral surface of said operating body and the inner peripheral surface of said cover body, said ring body is capable of expanding or contracting, a first coil spring is interposed in a longitudinally oriented state between a front end face of said operating body and the front inner peripheral surface of said cover body which is situated in front of said front end face, a second coil spring is interposed in a longitudinally oriented state between a rear end face of said operating body and the rear inner peripheral surface of said cover body which is situated in the rear side of said front end face, and when a gas is introduced into the rear side of said operating body, said operating body is pushed forward, and when said operating body is pushed forward to move forward, said first coil spring is elastically contracted to urge said operating body backward, and said second coil spring is elastically contracted to urge said operating body forward.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings, wherein:

FIG. 1 is a vertical cross-sectional view, showing an impact tool according to an embodiment of the present invention;

FIG. 2 is a vertical cross-sectional view, illustrating a state of the impact tool when compressed air is introduced;

FIG. 3 is a cross-sectional view, taken along the line A-A of FIG. 1;

FIG. 4 is a partially cross-sectional enlarged view, showing the interior of a cylinder portion;

FIG. 5A is a side view of a tubular main body;

FIG. 5B is a cross-sectional view, taken along the line B-B of FIG. 5A;

FIG. 5C is an external perspective view of a ring body;

FIG. 6A is a front view;

FIG. 6B is a partially cut side view;

FIG. 6C is a partially enlarged side view of a vibration absorbing body; and

FIG. 7 is a partially cut side view, showing another vibration absorbing body.

### DESCRIPTION OF THE EMBODIMENTS

The embodiments will now be described with reference to the accompanying drawings, wherein like reference numerals designate corresponding or identical elements throughout the various drawings.

The impact tool according to embodiments of the present invention will be described below with reference to the accompanying drawings of an air hammer tool as an example.

For convenience of description, it is considered that a tip direction of the impact tool is front and a base end direction is rear. However, it should not be construed as excluding the impact tool which is used in an upward or downward direction. Further, a gist of the present invention is not limited to the following embodiments, but any design change can be appropriately made without departing from the scope of the present invention.

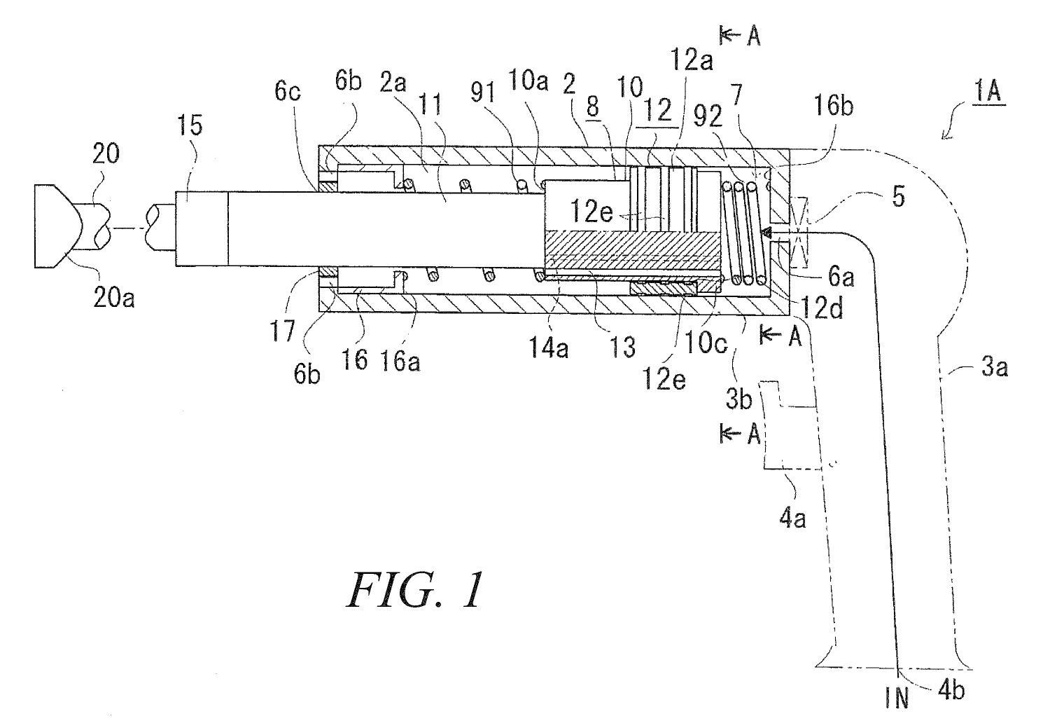

As shown in FIG. 1, an impact tool 1A is an air hammer tool using compressed air (gas) and includes a cover body 2 in which the compressed air is introduced from the outside, and a distal end work tool 20 which extends forward from the cover body 2.

The cover body 2 is made of a metal material and has a grip portion 3a which is grasped by a worker during work and a main body portion 3b having a substantially cylindrical shape which is continuously formed on the top of the grip portion 3a to extend along the longitudinal direction.

A trigger portion 4a is positioned at a front face portion of the grip portion 3a. Operation of the trigger portion 4a enables control of the supply of the compressed air to the impact tool 1A. Further, an air supply port 4b for introducing the compressed air from the outside is formed at the lower end of the grip portion 3a.

As a compressed air introducing mechanism, which introduces the compressed air into the cover body 2 from the outside and enables flexible control of the inflow of the compressed air by the trigger portion 4a, a well-known mechanism is suitably adopted.

The main body portion 3b has an inner space portion 2a formed along the longitudinal direction. Further, a gas pressure-injection portion 6a for introducing the compressed air into the inner space portion 2a is formed at the rear end of the main body portion 3b. A valve 5 is also attached to the gas pressure-injection portion 6a. The compressed air introduced from the grip portion 3a flows into the inner space portion 2a of the main body portion 3b through the valve 5. Further, a gas discharge portion 6b is formed at the front end of the main body portion 3b, enabling the compressed air introduced into the inner space portion 2a to be discharged therefrom.

Further, a cylindrical-shaped operating body 8 is fitted to be longitudinally slidable in the inner space portion 2a of the main body portion 3b. The operating body 8 is made of a metal material and has an operating body main body portion 10 having a large diameter, and a cylinder portion 11 having a small diameter and extending forward from the center of a front end face 10a of the operating body main body portion 10 as shown in FIG. 1. A large-diameter portion 10c having a larger diameter is formed at a rear part of the operating body main body portion 10.

The cylinder portion 11 protrudes from the cover body 2 through a cylinder portion extension opening 6c which opens at the front end of the main body portion 3b. A bearing member 17 is inscribed inside the inner edge of the cylinder portion extension opening 6c, and the cylinder portion 11 is slidably supported by the bearing member 17.

Further, in the inner space portion 2a of the main body portion 3b, a highly airtight compressed air inflow chamber 7 is formed in the rear side of the operating body 8.

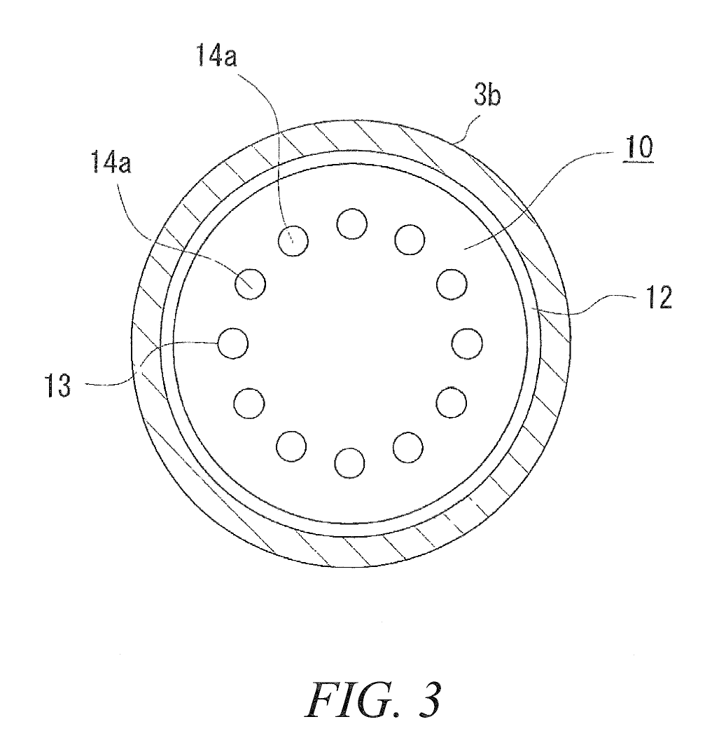

As shown in FIG. 3, plural gas passages are formed through the inside of the operating body main body portion 10. Among the plural gas passages, a gas discharge relay portion 13 is configured with the gas passage which communicates between the compressed air inflow chamber 7 and the gas discharge portion 6b of the main body portion 3b. A gas introduction portion 14a is composed of a gas passage which communicates the compressed air inflow chamber 7 and the inside of the cylinder portion 11.

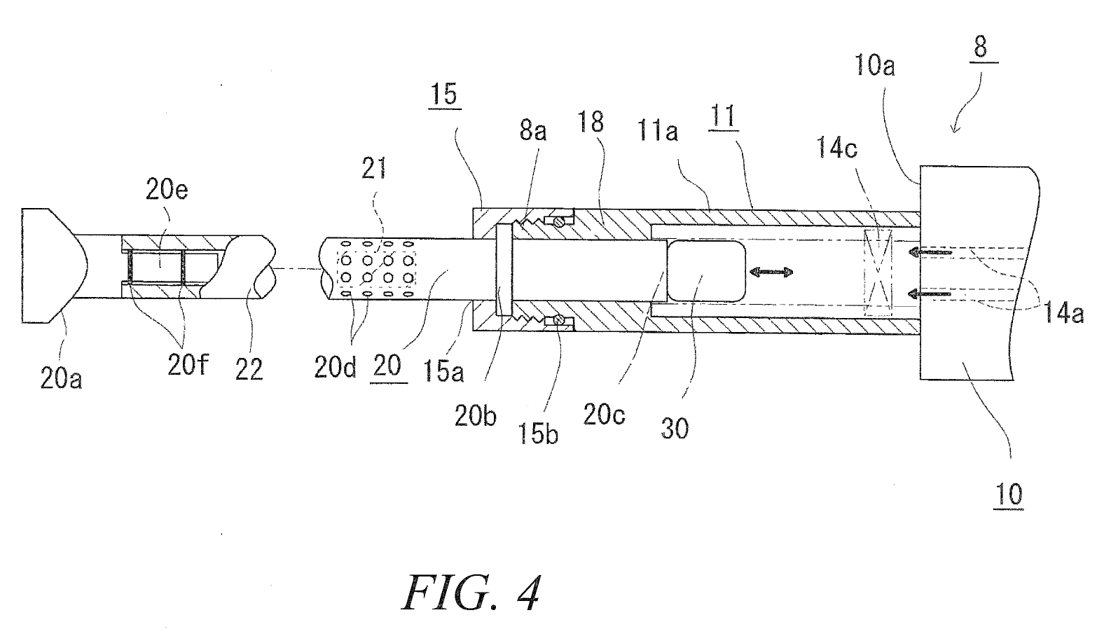

In addition, as shown in FIG. 4, the cylinder portion 11 of the operating body 8 has an outer cylinder portion 11a. Further, a supply-exhaust switching valve 14c is disposed at a base end portion in the outer cylinder portion 11a. On the other hand, a loading portion 18, which is formed by inward thickening a peripheral wall around a front-end opening portion 8a, is formed at the front-end opening portion 8a of the outer cylinder portion 11a, and the distal end work tool 20 is disposed to the loading portion 18.

The distal end work tool 20 is made of a metal material, has an end tool main body 22, and also has a pile-shaped chisel portion 20a which is attached to an end of the end tool main body 22, a disc-shaped retaining portion 20b which is formed at an intermediate portion of the end tool main body 22, and a rear end portion 20c which protrudes rearward from the center or the retaining portion 20b. Further, the rear end portion 20c of the distal end work tool 20 is inserted into the loading portion 18 through the front-end opening portion 8a of the outer cylinder portion 11a and extends into the cylinder portion 11, and a surface of the retaining portion 20b contacts with the end face of the outer cylinder portion 11a. In addition, this contact portion is covered with a cap-shape chuck body 15 which has an end tool insertion hole 15a, through which the distal end work tool 20 is inserted, formed at the center. With the chuck body 15 put on, the retaining portion 20b is held between the inner face of the chuck body 15 and the tip end face of the outer cylinder portion 11a, and the chuck body 15 and the tip end portion of the cylinder portion 11 are screwed in each other via an O-ring 15b, which is attached to the outer periphery of the loading portion 18. Thus, the distal end work tool 20 is firmly fixed so that it does not drop off from the cylinder portion 11. Incidentally, the chuck body 15 is detachable from the cylinder portion 11; therefore, the distal end work tool 20 is replaceable. The attaching structure of the distal end work tool 20 is not limited to the structure described above, and other structures may be adopted as a matter of course.

Next, the structure of the distal end work tool 20 is described below in further detail.

As shown in FIG. 4, a shaft portion 20e is continuously formed at a base end portion of the chisel portion 20a, and O-rings 20f are fitted on the shaft portion 20e. Further, the shaft portion 20e is fitted into and fixed to the front end of the end tool main body 22. The shaft portion 20e is detachable from the end tool main body 22, and the chisel portion 20a can thereby be appropriately replaced.

Further, as shown in FIG. 4, a portion in front of the retaining portion 20b of the end tool main body 22 is formed to have a cylindrical shape. Further, the inside of the end tool main body 22 is filled with a cushioning material 21 made of a fibrous material such as felt (a needle punched non-woven fabric) consisting of polyester fiber to reduce noise by the fibrous material. In addition, plural heat radiation holes 20d for preventing the cushioning material 21 from having an excessive temperature rise due to obtained heat energy are formed in the peripheral wall of the end tool main body 22 at the portion where the cushioning material 21 fills.

Next, the cylinder portion 11 will be described in detail.

A hammer 30 made of a metal material is fitted in the outer cylinder portion 11a of the cylinder portion 11 in a longitudinally slidable manner. For the hammer 30, the size and weight are set optimum as appropriate.

As shown in FIG. 1, the impact tool 1A is provided with a first coil spring 91 and a second coil spring 92.

More specifically, the cover body 2 has an annular spring stop portion 16 formed at the front end of the main body portion 3b, and the first coil spring 91 is interposed in a longitudinally oriented state between the operating body 8 and the end face 16a of the spring stop portion 16 forming the inner peripheral surface in the front side of the cover body 2. The first coil spring 91 functions as a compression spring.

On the other hand, the second coil spring 92 is interposed in the longitudinally oriented state between the operating body 8 and an inner peripheral surface 16b in the rear side of the cover body 2. Further, in the above fitted state, the second coil spring 92 is in an elastically contracted state and urges the operating body 8 forward.

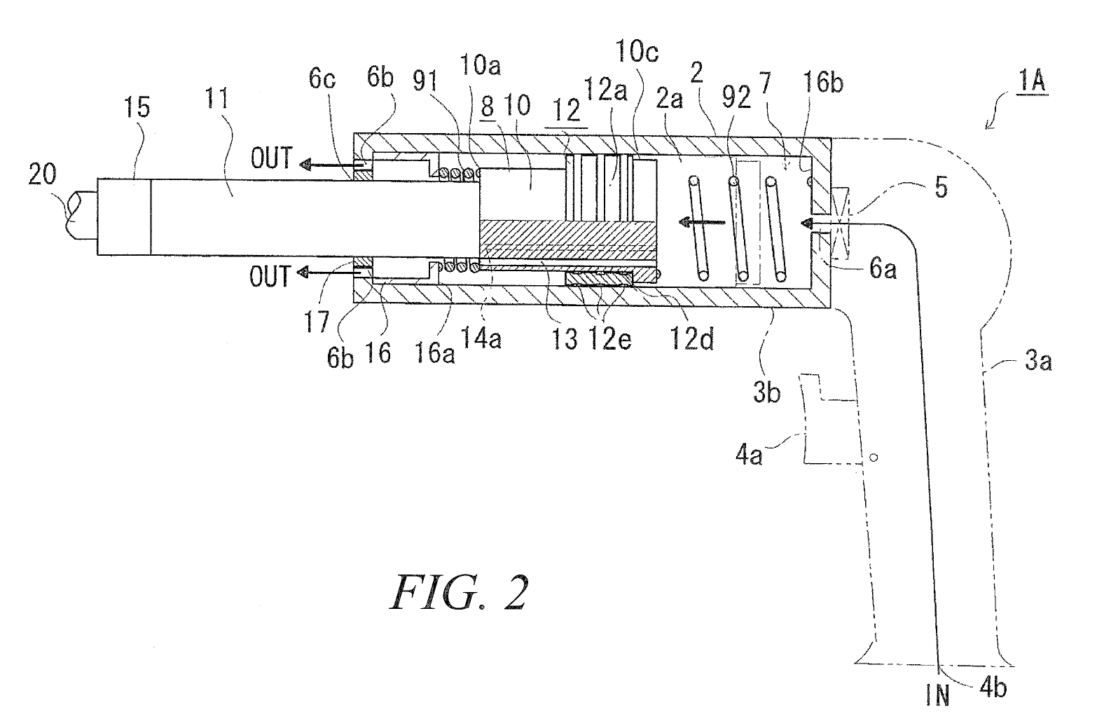

When the above impact tool 1A is used, the end of the distal end work tool 20 is pushed against a workpiece (not shown) such as a rock or a concrete block, and the trigger 4a is operated. Then, the compressed air is continuously injected into the compressed air inflow chamber 7 through the gas pressure-injection portion 6a of the main body portion 3b while the valve 5 prevents reverse flow to the air supply port 4b. The increased pressure in the compressed air inflow chamber 7 causes the operating body 8 to be pushed forward as shown in FIG. 2. When the operating body 8 is pushed forward, the volume of the compressed air inflow chamber 7 is increased, and the first coil spring 91 is elastically contracted between the spring stop portion 16 and the operating body 8, resulting in the operating body 8 being urged rearward. The first coil spring 91 does not collapse in this state. If the first coil spring 91 collapses, the vibration of the hammer 30 is transmitted to the cover body 2. On the other hand, although the second coil spring 92 extends in comparison with the state before the compressed air is introduced, the second coil spring 92 continues to be in the elastically contracted state (not fully stretched state) and ensures to urge the operating body 8 forward. The second coil spring 92 is not fully stretched in this state. If the second coil spring 92 is fully stretched, the second coil spring 92 cannot urge the operating body 8 forward, and thus the striking force decreases. Optimum spring constants are selected for the first coil spring 91 and the second coil spring 92, respectively, in order to achieve the states described above when the compressed air is introduced.

Further, the compressed air which is injected into the main body portion 3b is discharged from the gas discharge portion 6b to the outside of the cover body 2 through the gas discharge relay portion 13 formed in the operating body main body portion 10. At the same time, the compressed air which is injected into the main body portion 3b is introduced into the cylinder portion 11 through the gas introduction portion 14a of the operating body main body portion 10, and its flowing direction is appropriately controlled by the supply-exhaust switching valve 14c to make the hammer 30 perform a reciprocating motion in the longitudinal direction. The hammer 30 performing the reciprocating motion repeatedly impacts against the rear end portion 20c of the end tool 20. Thus, a striking force is applied continually to the workpiece through the distal end work tool 20. As the mechanism in which the hammer 30 performs a reciprocating motion in the cylinder portion 11, a well-known mechanism can be adopted suitably. For example, the well-known mechanism disclosed in Japanese Patent Application Publication No. H9-11156 can be applied to the impact tool 1A.

In the above structure, a vibration absorption effect can be obtained by the first coil spring 91 on the front side. Further, the pressure of the compressed air is complemented by the second coil spring 92 on the back side to push appropriately the operating body 8 forward, and the stabilizing effect of keeping the striking force constant can thereby be obtained.

Here, since the second coil spring 92 is set to have an appropriate spring constant, the striking force applied to the workpiece can be adjusted while the optimum vibration absorption effect and noise reduction effect are maintained.

For example, when it is desired to increase the striking force, a spring constant of the second coil spring 92 is changed to increase the urging force applied forward to the operating body 8. Then, the operating body 8 is strongly urged forward, the distal end work tool 20 is strongly pushed against the workpiece accordingly, the impact force applied to the workpiece increases, the operating body 8 is prevented from jumping backward in the inner space portion 2a, and thus a loss of the striking force decreases with respect to the compressed air that is introduced. On the other hand, when it is desired to decrease the impact force, the spring constant of the second coil spring 92 is changed to reduce the urging force applied forward to the operating body 8. Then, the impact force decreases because the above-described reverse principle functions in the reversed manner.

Next, a vibration absorbing body 12 will be described in detail.

As shown in FIG. 1 and other drawings, a tubular vibration absorbing body 12 is disposed on the outer peripheral surface of the operating body main body portion 10 and in the front side of the large-diameter portion 10c. More specifically, the vibration absorbing body 12 is fitted on the outside of the operating body main body portion 10 in the front side of the large-diameter portion 10c and interposed between the outer peripheral surface of the operating body main body portion 10 and the inner peripheral surface of the cover body 2 in a longitudinally slidable manner.

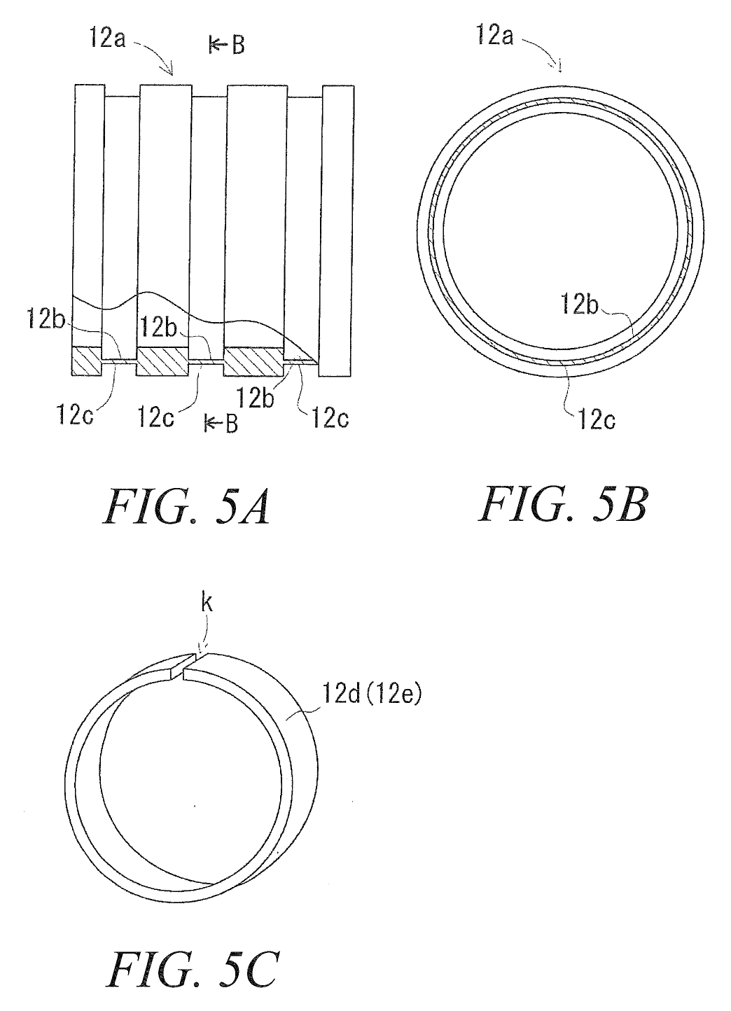

The vibration absorbing body 12 has a tubular main body 12a as shown in FIGS. 5A and 5B and a ring body 12d, 12e as shown in FIG. 5C. For example, the tubular main body 12a is preferably made of a rigid resin, and the ring body 12d, 12e is preferably made of metal.

As shown in FIGS. 5A and 5B, plural recessed grooves 12b and 12c are faulted in the inner peripheral surface and the outer peripheral surface of the tubular main body 12a along its the circumferential direction. The recessed groove 12b on the inner peripheral surface side and the recessed groove 12c on the outer peripheral surface side are respectively formed in a position opposite to each other in the inner peripheral surface and the outer peripheral surface of the tubular main body 12a.

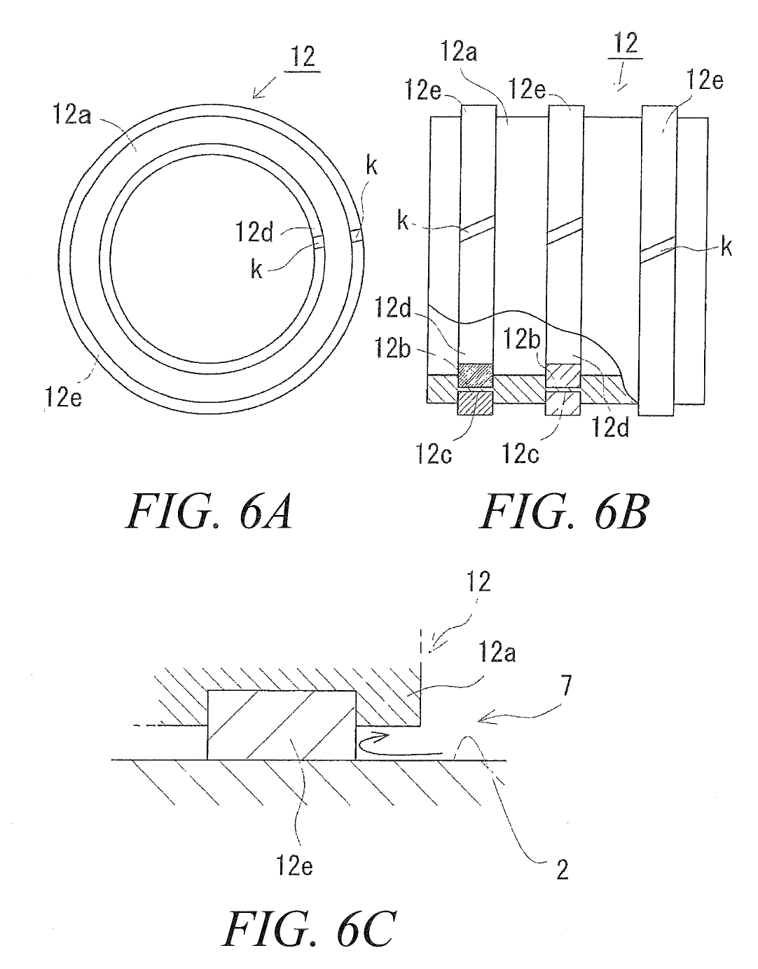

On the other hand, as shown in FIG. 5C, the ring body 12d(12e) has a gap k by means of the cutting of a part of the ring body and is configured to be a commonly-known wear ring in a C shape in which the whole becomes elastically deformed and thus its outside diameter expands or contracts. In addition, the ring body 12d, 12e has a rectangular shape in section when cut in the plane including the central axis of the ring. As shown in FIGS. 6A, 6B, and 6C, the ring bodies 12d and 12e are fitted and mounted in the recessed grooves 12b and 12c, respectively. In this embodiment, the structure is such that the plural ring bodies 12d and 12e are disposed in parallel on the inner peripheral surface and the outer peripheral surface of the tubular main body 12a along the central axis direction of the tubular main body 12a; however, the structure may be such that only one set of the ring bodies 12d and 12e are disposed on the inner peripheral surface and the outer peripheral surface respectively.

In the state that the vibration absorbing body 12 is interposed between the outer peripheral surface of the operating body main body portion 10 and the inner peripheral surface of the cover body 2, as shown in FIG. 1 and other drawings, the ring bodies 12d and 12e can freely expand and contract. In this state, the inner peripheral surface of the ring body 12d attached to the inner peripheral surface of the tubular main body 12a comes into surface contact with the outer peripheral surface of the operating body main body portion 10, and the outer peripheral surface of the ring body 12e attached to the outer peripheral surface of the tubular main body 12a comes into surface contact with the inner peripheral surface of the cover body 2 (see FIGS. 1 and 2).

The airtightness of the compressed air inflow chamber 7 is highly maintained accordingly, and the operating body 8 is supported in a longitudinally and radially movable manner and prevented from rattling. Specifically, the ring bodies 12d and 12e in the elastically contracted state absorb the vibration occurring in the operating body 8 due to the impact by the hammer 30 in use and transmitted in the radial direction or the vibration of the operating body 8 itself in the radial direction by responding to the vibration and slightly expanding or contracting its outside diameter, and therefore the ring bodies prevent the vibration from being transmitted to the cover body 2. For example, the ring body 12d arranged on the inner peripheral surface side of the tubular main body 12a prevents the operating body 8 and the tubular main body 12a from coming excessively close to each other. On the other hand, the ring body 12e arranged on the outer peripheral surface side of the tubular main body 12a prevents the cover body 2 and the tubular main body 12a from coming excessively close to each other.

As shown in FIG. 6C, annular side surfaces of the ring bodies 12d and 12e facing to the side of the compressed air inflow chamber 7 are approximately orthogonal to the outer peripheral surface of the operating body 8 and the inner peripheral surface of the cover body 2. Then, as shown in FIG. 6C, when the compressed air injected into the compressed air inflow chamber 7 flows from the gap between the outer peripheral surface of the operating body 8 and the inner peripheral surface of the cover body 2 toward the front side, the side surfaces of the ring bodies 12d and 12e stem a large amount of the compressed air flowing forward, and thus the compressed air injected from the compressed air inflow chamber 7 can be prevented from leaking excessively. The leakage of the compressed air which is injected (air loss) can be prevented accordingly.

The structure of the vibration absorbing body 12 is such that the ring bodies 12d and 12e are attached to follow the periphery of the tubular main body 12a in which the central axis is determined as the longitudinal direction and the vibration absorbing body is fitted around the outside of the operating body 8, and thus the outside diameter of the vibration absorbing body 12 does not become excessively large. Therefore, the outside diameter of the cover body 2 can be made as small as possible, and the weight of the impact tool 1A can be reduced.

### Embodiment 2

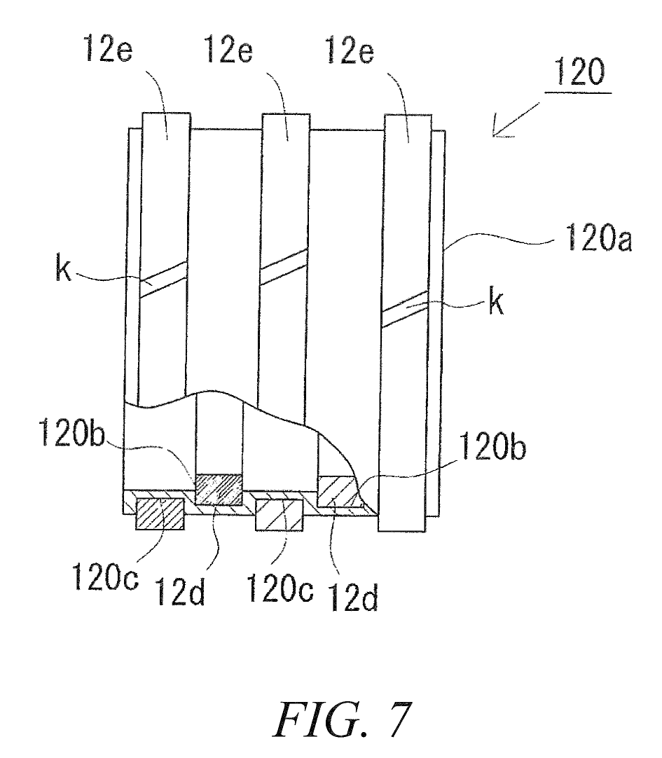

As shown in FIG. 7, a vibration absorbing body 120 includes a tubular main body 120a. Plural recessed grooves 120b and 120c are formed in the inner peripheral surface and the outer peripheral surface of the tubular main body 120a along its the circumferential direction, and the ring bodies 12d and 12e are attached to be fitted into the recessed grooves 120b and 120c. The recessed grooves 120b and 120c where the ring bodies 12d and 12e are attached are formed in the positions not opposed to each other on the inner peripheral surface and the outer peripheral surface of the tubular main body 120a and have a structure in a staggered arrangement of the ring body 12d and the ring body 12e.

According to the above structure, the desired depth of the recessed groove 120b, 120c capable of preventing detachment from the ring body 12d, 12e can be secured, while the wall thickness of the tubular main body 120a can be reduced as a whole. Therefore, the outside diameter of the vibration absorbing body 120 can be reduced more, and the size reduction and the weight reduction of the impact tool 1A can be achieved as a whole.

According to the embodiments of the present invention, the distal end work tool 20 may be, for example: a chisel for a rock drill, a concrete breaker or a chipping machine; a nail, a rivet or a pile for a nailer, a riveting machine or a pile driver; a ground leveling plate for a land leveler, a compactor, a rammer, a tamper, a road roller or a ground leveling machine; or a needle bunch for a jet chisel. In addition, an impact tool according to the embodiments of the present invention can adapt to the structure such as a grinder or an impact wrench that the operating body 8 mounted inside rotates about the axis along the longitudinal direction of the cover body 2 as a matter of course. The gas to be pressurized and injected into the impact tool 1A is not limited to the compressed air but maybe a gas such as an inert gas.

Although the material of the tubular main body 12a, 120a of the vibration absorbing body 12, 120 is not limited specifically, a rigid resin or metal is preferably adopted basically. When the tubular main body 12a is made of the rigid resin, in order to prevent the distortion of the rigid resin, the recessed grooves 12b and 12c where the ring bodies 12d and 12e are attached are preferably formed in the positions opposite to each other on the inner peripheral surface and the outer peripheral surface of the tubular main body 12a, respectively. On the other hand, when the tubular main body 12a is made of metal, the recessed grooves 120b and 120c where the ring bodies 12d and 12e are attached are preferably formed in the staggered arrangement on the inner peripheral surface and the outer peripheral surface of the tubular main body 12a. This is because the weight can be reduced by the reduction of the wall thickness of the tubular main body 12a.

Although the number of the ring bodies 12d and 12e is not particularly specified in the embodiments of the present invention, the vibration absorbability can be improved when two or more respective ring bodies are formed. In addition, specifically, when the compressed air inflow chamber 7 is formed in the vicinity, the high airtightness of the compressed air inflow chamber 7 can be retained.

According to one aspect of the present invention, an impact tool includes a cover body and a distal end work tool extending forward from said cover body for performing a task by abutment of said distal end work tool against a workpiece while gas is introduced into the inside of said cover body, wherein said cover body has an inner space portion formed along a longitudinal direction, a cylindrical operating body moving in the longitudinal direction or rotating about an axis along the longitudinal direction is mounted in said inner space portion, when gas is introduced to a rear side of said operating body, a hammer provided in said operating body reciprocates to impact repeatedly the distal end work tool thereby transmitting an impact force to the workpiece, a vibration absorbing body is disposed to be fitted on the outside of said operating body and interposed between an outer peripheral surface of said operating body and an inner peripheral surface of said cover body, said vibration absorbing body includes a tubular main body, and an elastically deformable ring body mounted onto each of an inner peripheral surface and an outer peripheral surface of said tubular main body along the circumferential direction, in a state where said vibration absorbing body is interposed between the outer peripheral surface of said operating body and the inner peripheral surface of said cover body, the inner peripheral surface of said ring body mounted on the inner peripheral surface of said tubular main body comes into contact with the outer peripheral surface of said operating body, and the outer peripheral surface of said ring body mounted on the outer peripheral surface of said tubular main body comes into contact with the inner peripheral surface of said cover body, said ring body is partially cut to have a gap and becomes elastically deformable to expand or contract the outside diameter of said ring body, in the state where said vibration absorbing body is interposed between the outer peripheral surface of said operating body and the inner peripheral surface of said cover body, said ring body is capable of expanding or contracting, a first coil spring is interposed in a longitudinally oriented state between a front end face of said operating body and the front inner peripheral surface of said cover body which is situated in front of said front end face, a second coil spring is interposed in a longitudinally oriented state between a rear end face of said operating body and the rear inner peripheral surface of said cover body which is situated in the rear side of said front end face, and when a gas is introduced into the rear side of said operating body, said operating body is pushed forward, and when said operating body is pushed forward to move forward, said first coil spring is elastically contracted to urge said operating body backward, and said second coil spring is elastically contracted to urge said operating body forward.

In the above structure, the vibration occurring in the operating body by the reciprocating motion of the hammer is suitably absorbed by the ring body of the vibration absorbing body which can freely expanded or contracted. Therefore, the large vibration is hardly transmitted to the hands of the worker holding the cover body. More specifically, the vibration occurring in the operating body includes the vibration transmitted to the ring body along the radial direction of the operating body and the vibration of the operating body itself in the radial direction. The ring body slightly expands or contracts in response to the complex vibrations described above and effectively absorbs the vibrations. Specifically, the ring body arranged on the inner peripheral surface side of the tubular main body prevents the operating body and the tubular main body from coming excessively close to each other so as to resist the vibration. If the operating body and the tubular main body come into contact with each other, the vibration is fully transmitted in this event, and the vibration absorption effect cannot be achieved. On the other hand, the ring body arranged on the outer peripheral surface side of the tubular main body prevents the cover body and the tubular main body from coming excessively close to each other so as to resist the vibration. If the cover body and the tubular main body come into contact with each other, the vibration is fully transmitted in this event, and the vibration absorption effect cannot be achieved. The structure of the vibration absorbing body is such that the ring bodies are attached to follow the periphery of the tubular main body in which the central axis is determined as the longitudinal direction and the vibration absorbing body is fitted around the outside of the operating body, and thus the outside diameter of the vibration absorbing body does not become excessively large. Therefore, there are advantages that the outside diameter of the cover body can be made as small as possible, and the weight of the impact tool can be reduced. If coil springs are arranged along the radial direction in order to absorb the vibration, for example, the outside diameter of the cover body exceedingly becomes large. When the vibration is absorbed effectively, the noise-reduction effect improves accordingly.

In addition, the structure is proposed such that the recessed grooves are formed in the inner peripheral surface and the outer peripheral surface of said tubular main body of said vibration absorbing body along the circumferential direction, and the ring bodies are attached to the recessed grooves, respectively.

According to the above structure, the ring body does not come off its proper position, and the vibration absorption effect can be securely retained.

In addition, the structure is proposed such that said ring body has a rectangular shape in section when cut in the plane including the central axis of the ring, the inner peripheral surface of said ring body mounted on the inner peripheral surface of said tubular main body comes into surface contact with the outer peripheral surface of said operating body, and the outer peripheral surface of said ring body mounted on the outer peripheral surface of said tubular main body comes into surface contact with the inner peripheral surface of said cover body.

According to the above structure, the side surface of the ring body facing to the side of the compressed air inflow is approximately orthogonal to the outer peripheral surface of the operating body and the inner peripheral surface of the cover body. Then, when the compressed air injected into the compressed air inflow chamber flows toward the gap between the outer peripheral surface of the operating body and the inner peripheral surface of the cover body, the side surface of the ring body stems the compressed air flowing forward, and thus the compressed air injected into the compressed air inflow chamber can be prevented from leaking from the compressed air inflow chamber. The airtightness of the compressed air inflow chamber can improves accordingly, and the leakage of the compressed air which is injected (air loss) can be prevented.

Furthermore, it is desired that a plurality of said ring bodies are disposed in parallel in a central axis direction of said tubular main body on the inner peripheral surface and the outer peripheral surface of said tubular main body.

According to the above structure, the vibration absorption effect improves further.

In addition, a method of adjusting an impact force in the impact tool described above may be adopted, characterized in that when a spring constant of the second coil spring is changed to increase a forward urging force against the operating body, the operating body is strongly pushed forward, and the impact force exerted on the workpiece increases, and when the spring constant of the second coil spring is changed to reduce the forward urging force against the operating body, the impact force exerted on the workpiece decreases.

According to the above structure, the impact force can properly increase or decrease depending on the usage environment.

The impact tool according to the embodiments of the present invention has effects such that vibration and noise transmitted to the worker are reduced remarkably, and it can be manufactured at a low cost and easily maintained because it has a simple and light-weight structure.

Furthermore, the method of adjusting an impact force according to the embodiments of the present invention has an effect such that the impact force can properly increase or decrease depending on the usage environment.

Obviously, numerous modifications and variations of the present invention are possible in light of the above teachings. It is therefore to be understood that within the scope of the appended claims, the invention may be practiced otherwise than as specifically described herein.

What is claimed is:

1. An impact tool comprising a cover body and a distal end work tool extending forward from said cover body for performing a task by abutment of said distal end work tool against a workpiece while a gas is introduced into the inside of said cover body, wherein
said cover body includes: an inner space portion formed along a longitudinal direction; and a cylindrical operating body moving in the longitudinal direction or rotating about an axis along the longitudinal direction is mounted in said inner space portion,
when a gas is introduced to a rear side of said operating body, a hammer provided in said operating body reciprocates to impact repeatedly the distal end work tool, thereby transmitting an impact force to the workpiece,
a vibration absorbing body is provided so as to be fitted to the outside of said operating body and interposed between an outer peripheral surface of said operating body and an inner peripheral surface of said cover body,
said vibration absorbing body includes: a tubular main body; and an elastically deformable ring body mounted onto each of an inner peripheral surface and an outer peripheral surface of said tubular main body along a circumferential direction,
in a state where said vibration absorbing body is interposed between the outer peripheral surface of said operating body and the inner peripheral surface of said cover body, the inner peripheral surface of said ring body mounted on the inner peripheral surface of said tubular main body comes into contact with the outer peripheral surface of said operating body, and the outer peripheral surface of said ring body mounted on the outer peripheral surface of said tubular main body comes into contact with the inner peripheral surface of said cover body,
said ring body is partially cut to have a gap and becomes elastically deformable to expand or contract an outside diameter of said ring body,
in a state where said vibration absorbing body is interposed between the outer peripheral surface of said operating body and the inner peripheral surface of said cover body, said ring body is capable of expanding or contracting,
a first coil spring is interposed in a longitudinally oriented state between a front end face of said operating body and a front inner peripheral surface of said cover body which is situated in front of said front end face,
a second coil spring is interposed in a longitudinally oriented state between a rear end face of said operating body and a rear inner peripheral surface of said cover body which is situated in a rear side of said front end face, and
when a gas is introduced into the rear side of said operating body, said operating body is pushed forward, and when said operating body is pushed forward to move forward, said first coil spring is elastically contracted to urge said operating body backward, and said second coil spring is elastically contracted to urge said operating body forward.

2. The impact tool according to claim 1, wherein recessed grooves are formed in the inner peripheral surface and the outer peripheral surface of said tubular main body of said vibration absorbing body along the circumferential direction, and the ring bodies are attached to the recessed grooves, respectively.

3. The impact tool according to claim 2, wherein said ring body has a rectangular shape in section when cut in a plane including the central axis of the ring, the inner peripheral surface of said ring body mounted on the inner peripheral surface of said tubular main body comes into surface contact with the outer peripheral surface of said operating body, and the outer peripheral surface of said ring body mounted on the outer peripheral surface of said tubular main body comes into surface contact with the inner peripheral surface of said cover body.

4. The impact tool according to claim 1, wherein a plurality of said ring bodies are disposed in parallel in a central axis direction of said tubular main body on the inner peripheral surface and the outer peripheral surface of said tubular main body.

5. A method of adjusting an impact force in the impact tool according to claim 1, wherein when a spring constant of the second coil spring is changed to increase a forward urging force against the operating body, the operating body is strongly pushed forward, and the impact force exerted on the workpiece increases, and when the spring constant of the second coil spring is changed to reduce the forward urging force against the operating body, the impact force exerted on the workpiece decreases.
